(19) United States
(12) Patent Application Publication
(10) Pub. No.: US 2024/0012690 A1
(43) Pub. Date: Jan. 11, 2024

(54) DEVICE AND METHOD FOR PARTITIONING ACCELERATOR AND BATCH SCHEDULING

(71) Applicants: SAMSUNG ELECTRONICS CO., LTD., Suwon-si (KR); Korea Advanced Institute of Science and Technology, Daejeon (KR)

(72) Inventors: Minsoo RHU, Daejeon (KR); Yunseong KIM, Daejeon (KR); Yujeong CHOI, Daejeon (KR)

(73) Assignees: SAMSUNG ELECTRONICS CO., LTD., Suwon-si (KR); Korea Advanced Institute of Science and Technology, Daejeon (KR)

(21) Appl. No.: 18/348,667

(22) Filed: Jul. 7, 2023

(30) Foreign Application Priority Data
Jul. 8, 2022 (KR) 10-2022-0084124

(51) Int. Cl. G06F 9/50; G06F 9/48

(52) U.S. Cl. CPC G06F 9/5061; G06F 9/5027; G06F 9/4881; G06F 2209/503; G06F 2209/5022

(57) ABSTRACT

An electronic device and method for partitioning an accelerator and scheduling batches are disclosed. An electronic device includes one or more processors, and a memory storing instructions configured to cause the one or more processors to, for a first partitioning of an accelerator into partitions of different sizes, based on resource utilization of the partitions batch of different sizes input to the partition, determine correspondences between the sizes of the batches and the sizes of the partitions in the first partitioning, determine numbers of partitions for the respective determined sizes of the partitions based on the correspondences between the sizes of the batches and the sizes of the partitions in the first partitioning, and partition the accelerator into a second partitioning based on the determined numbers of the respective sizes of the partitions.

### CROSS-REFERENCE TO RELATED APPLICATIONS

This application claims the benefit under 35 USC § 119(a) of Korean Patent application No. 10-2022-0084124, filed on Jul. 8, 2022, in the Korean Intellectual Property Office, the entire disclosure of which is incorporated herein by reference for all purposes.

### BACKGROUND

### Field

The following description relates to a device and method for accelerator partitioning and batch scheduling.

### Description of Related Art

With increasing demand for artificial intelligence (AI) technology, demand for increasing throughput of a system processing an AI model has increased. Techniques for partitioning an accelerator that performs an AI operations and scheduling a query including a batch to a partition are used.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes one or more processors, and a memory storing instructions configured to cause the one or more processors to, for a first partitioning of an accelerator into partitions of different sizes, based on resource utilization of the partitions batch of different sizes input to the partition, determine correspondences between the sizes of the batches and the sizes of the partitions in the first partitioning, determine numbers of partitions for the respective determined sizes of the partitions based on the correspondences between the sizes of the batches and the sizes of the partitions in the first partitioning, and partition the accelerator into a second partitioning based on the determined numbers of the respective sizes of the partitions.

The resource utilization may be determined based on a neural network (NN) model executed by the partitions.

The instructions may be further configured to cause the one or more processors to determine the correspondences between the sizes of the batches and the sizes of the partitions based on a size of a batch corresponding to when the resource utilization of a partition corresponds to a preset threshold resource utilization.

The instructions may be further configured to cause the one or more processors to determine the numbers of partitions of respective sizes according to throughput based on the sizes of the partitions and the sizes of the batches.

The instructions may be further configured to cause the one or more processors to determine the numbers of partitions of respective sizes such that the number of batches by size corresponds to the number of batches by size which are processible based on the numbers of partitions of respective sizes.

The instructions may be further configured to cause the one or more processors to, when a batch is scheduled to the accelerator, calculate predicted execution times processing the batch by each of the respective partition sizes, based on a processing time determined based on the size of one or more partitions obtained by partitioning the accelerator and the size of the batch input to the partitions, and assign the batch to one of the partitions by comparing the predicted execution times with an execution time requirement that is associated with the batch.

The processing times may be determined based on a neural network (NN) model executed by the partitions.

The instructions may be further configured to cause the one or more processors to schedule the batch to a smallest partition among partitions for which the respectively corresponding predicted execution times meet the execution time requirement.

In one general aspect, an electronic device includes one or more processors and a memory storing instructions executable by the processor, wherein, in response to the instructions being executed by the one or more processors, the one or more processors: based on a processing time determined based on a size of one or more partitions obtained by partitioning an accelerator and a size of a batch input to each of the partitions, when the batch is scheduled to the accelerator, calculate predicted execution times for completing processing of the batch for each of the respective sizes of the partitions, and schedule the batch to one of the partitions by comparing the predicted execution times with an execution time requirement associated with the batch.

The processing times may be determined based on a neural network (NN) model executed by the partitions.

The instructions may further configure the one or more processors to calculate the predicted durations based on a remaining processing time of a batch that is currently processed by one of the partitions, a processing time of a batch that is already scheduled to one of the partitions, and a processing time of the batch.

The instructions may further configure the processor to schedule the batch to a smallest partition size among partition sizes for which the corresponding predicted execution times are earlier than the execution time requirement.

In one general aspect, a method manages an accelerator device that can be reconfigured to have different partitions that are capable of executing batches, and the method includes: providing associations between batch sizes and respective partition sizes, the batch sizes including amounts of data in the corresponding batches, the partition sizes including amounts of processing resources of the corresponding partitions, instantiating a number of instances of partitions for each of the respective partition sizes based on information about frequencies of batches for the respective batch sizes, and assigning batches to the instantiated instances of partitions, wherein the batches are assigned to instances of partitions that have partition sizes associated with, according to the associations, the sizes of the batches.

The associations may be determined based on a resource utilization threshold.

The information about frequencies of batches for the respective batch sizes may be determined based on statistics of the sizes of partitions and the sizes of batches.

Numbers of instances of partitions for the respective partition sizes may be determined such that the number of instances of a partition of a given size is proportional to a frequency of processing batches of a corresponding size.

The accelerator device may be a multi-instance graphics processing unit (GPU).

A partition size may correspond to a number of graphics processing clusters.

The assigning of a batch to an instantiated instance of a partition may further include predicting execution times of the batch for the respective partition sizes and assigning the batch to an instance of a partition having the lowest predicted execution time.

The associations between the batch sizes and the respective partition sizes may be determined based on historical statistics of executions of previous batches by previous partitions of the accelerator having the partition sizes.

Other features and aspects will be apparent from the following detailed description, the drawings, and the claims.

### BRIEF DESCRIPTION OF THE DRAWINGS

FIG. 1A illustrates an electronic device according to one or more embodiments.

FIG. 1B illustrates an electronic device and a server according to one or more embodiments.

FIG. 2 illustrates an accelerator partitioned according to one or more embodiments.

FIG. 3 illustrates an operation of partitioning an accelerator and an operation of scheduling a batch according to one or more embodiments.

FIG. 4 illustrates resource utilization and latency based on a neural network (NN) model, according to one or more embodiments.

FIG. 5 illustrates resource utilization and latency based on a partition size and a batch size, according to one or more embodiments.

FIG. 6 illustrates batch size corresponding to partition size determined based on threshold resource utilization, according to one or more embodiments.

FIGS. 7A and 7B illustrate number of instances of partitions of different sizes as determined based on a batch size distribution, according to one or more embodiments.

FIG. 8 illustrates accelerator partitioning according to one or more embodiments.

FIG. 9 illustrates a calculated predicted execution time for a new query according to one or more embodiments.

FIG. 10 illustrates an operation of scheduling a query including a batch to partitions, according to one or more embodiments.

FIG. 11 illustrates an operation of scheduling a query including a batch to partitions, according to one or more embodiments.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

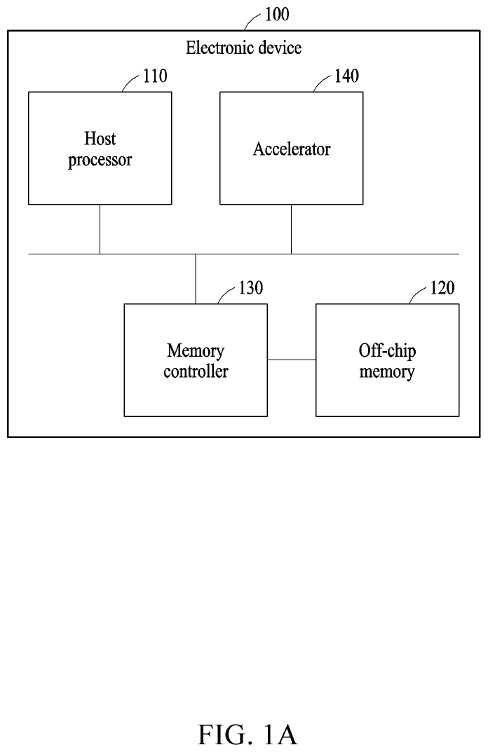

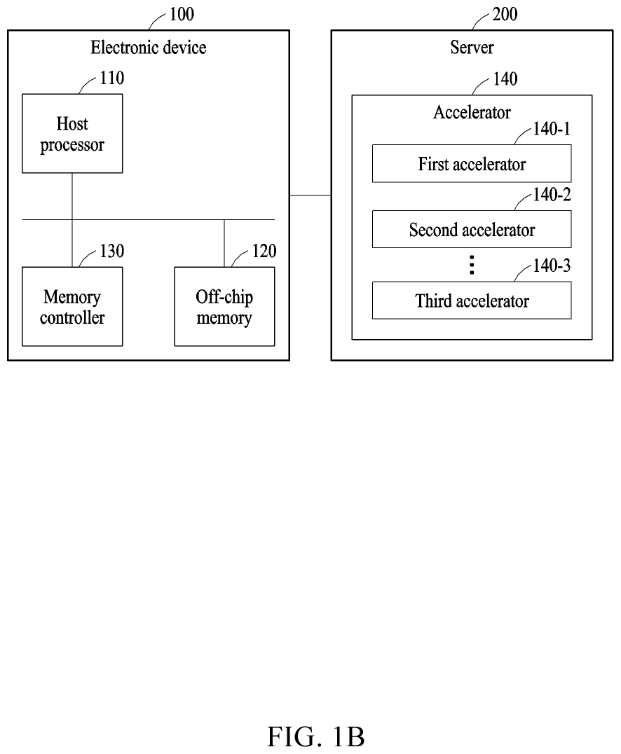

FIG. 1A illustrates an electronic device according to one or more embodiments. An electronic device 100 may include a host processor 110, an off-chip memory 120, a memory controller 130, and an accelerator 140. The host processor 110, the off-chip memory 120, the memory controller 130, and the accelerator 140 may communicate with one another through a bus, a network on a chip (NoC), a peripheral component interconnect express (PCle) bus, and/or the like. The electronic device 100 may be, or may include, for example, various computing devices, such as a mobile phone, a smartphone, a tablet personal computer (PC), an e-book device, a laptop, a PC, a server, various wearable devices such as a smart watch, smart eyeglasses, a head mounted display (HMD), or smart clothes, various home appliances such as a smart speaker, a smart television (TV), and a smart refrigerator, and other devices, such as a smart vehicle, a smart kiosk, an Internet of things (loT) device, a walking assist device (WAD), a drone, a robot, and the like.

The host processor 110 may be a device configured to control respective operations of components included in the electronic device 100 and may be, for example, a central processing unit (CPU), however the example is not limited thereto. The host processor 110 may control operations performed by the electronic device 100. The host processor 110 may execute a kernel and other operating system components to manage use of hardware resources of the electronic device 100, which may also be referred to as a server, a host, or the like. The host processor 110 may receive one or more requests for processing a neural network in the accelerator 140. Based on the neural network request(s), the host processor 110 may generate a kernel including instructions executable by the accelerator 140 and transfer the generated kernel to the accelerator 140. The request may be made for a neural network-based data inference (e.g., computing a prediction based on applying layers of weights of the neural network to an input to the neural network) and for obtaining a result of the data inference by allowing the accelerator 140 to execute the neural network for object recognition, pattern recognition, computer vision, speech recognition, machine translation, machine interpretation, recommendation services, personalized services, image processing, autonomous driving, or the like.

The off-chip memory 120 may be a memory located (or disposed) outside of the accelerator 140 and be, for example, dynamic random-access memory (DRAM), high bandwidth memory (HBM), and the like that is used as a main memory of the host processor 110, but is not limited to thereto. The off-chip memory 120 may store inference target data and/or parameters of the neural network to be executed by the accelerator 140, and data stored in the off-chip memory 120 may be transferred to the accelerator 140 for inferencing based thereon. The off-chip memory 120 may also be used in a case in which an on-chip memory inside the accelerator 140 is insufficient to execute the neural network in the accelerator 140.

The off-chip memory 120 may have a greater memory capacity than the on-chip memory in the accelerator 140. However, when the neural network is executing, the cost for the accelerator 140 accessing the off-chip memory 120 may be greater than the cost for the accelerator 140 accessing its own internal memory (e.g., on-chip memory). Costs of accessing off-chip memory 120 by the accelerator 140 may be power and/or access time.

The accelerator 140 may be an artificial intelligence (AI) accelerator that performs inferences on input data by executing the neural network, for example, based on a kernel transmitted from the host processor. The accelerator 140 may include a processors separate from the host processor 110. For example, the accelerator 140 may be a neural processing unit (NPU), a graphics processing unit (GPU), a tensor processing unit (TPU), or a digital signal processor (DSP), but is not limited thereto. In some embodiments, as described below, the accelerator 140 may be configured to enable partitioning the accelerator 140 into virtual accelerator devices (partitions) whose resources may be exclusive to respective user processes. For example, the accelerator 140 may be implemented as an NVIDIA (TM) Multi-instance GPU (MIG) and the partitions of the accelerator 140 may be MIG instances. Techniques described herein may be applied to any partitionable accelerator.

The accelerator 140 may process some neural network tasks more efficiently than the general-purpose host processor (the host processor 110) due to characteristics of the operations performed by the neural network. For some such neural network tasks, the on-chip memory and one or more processing elements (PEs) included in the accelerator 140 may be utilized for efficient neural network processing. The on-chip memory included in the accelerator 140 may store data necessary for performing a computation of the accelerator 140 or may include a global shared buffer and/or a local buffer for storing a computation result; the on-chip memory is be distinguished from the off-chip memory 120 located outside of the accelerator 140. For example, the on-chip memory may include a scratchpad memory accessible through an address space, static random-access memory (SRAM), or a system cache, but is not limited thereto.

In general, a neural network may provide an optimal output corresponding to an input by mapping an input and an output that are in a non-linear relationship, based on deep learning encoded into the neural network, e.g., in the form of weights. Deep learning may be for solving problems from a big data set and may optimize a neural network by determining parameters (e.g., weights) and/or structure of a model of the neural network. A neural network may include layers (e.g., an input layer, hidden layers, and an output layer). Each of the layers may include a respective plurality of nodes. Each node may be a calculation unit having one or more inputs and an output (e.g., an activation), and the nodes may be connected to each other. A weight may be set for a connection between two nodes and may be adjusted or changed through a learning or training algorithm. The weight may amplify, reduce, or maintain a relevant data value, thereby determining a degree of influence of the data value on a final result of the neural network. Weighted inputs of nodes included in a previous layer may be input to each node included in the output layer. A process of inputting weighted data from a layer to a next layer is referred to as propagation. For ease of description, neural networks described herein may also be referred to as models.

In some embodiments, the host processor 110 may form partitions (e.g., sizes and numbers of partition instances) by partitioning the accelerator 140. Operation requests processed by the accelerator 140 may have various batch sizes (sizes of units/batches of data to be processed). The resource utilization of the accelerator 140 over many batches may vary depending on the sizes of the batches and/or a neural network (NN) model being processed. For example, the host processor 110 may partition the accelerator 140 by considering a provided NN model and/or an input batch size. By doing so, the host processor 110 may increase resource utilization of the accelerator 140 (decrease the overall amount of idle time of the accelerator) and may also process an input query to satisfy an associated latency constraint (e.g., a requirement specified in a service level agreement (SLA)). The terms “query” and “request” are used interchangeably herein. Note that the terms “query/request” and “batch” are used interchangeably herein as there is usually a one-to-one correspondence between a query/request and a batch (although a query/request may request processing of more than one batch). However, a query generally refers to a request (e.g., a call to an application to an application programming interface or one or more processor instructions) and a batch refers to the actual data for which a request requests processing; a request will generally provide information on the location(s) and extent(s) of its batch data. In terms of partitioning and scheduling/assigning batches, properties of the batches, e.g., size and frequency, may inform partitioning and scheduling.

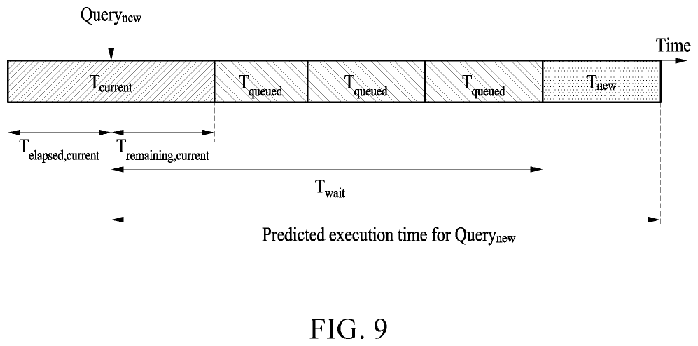

As mentioned above, the accelerator 140 may be divided into partitions. The host processor 110 may schedule input queries (i.e., assign batches of the input queries) to the partitions obtained based on partitioning of the accelerator 140 and based on the size (or predicted execution times) of the queries/batches. For example, the host processor 110 may calculate a predicted execution time (see FIG. 9) for completing processing of an input query and may schedule the query to one of the partitions by comparing the predicted execution time with a constrained or specified execution time (e.g., the SLA) that is established prior to the query (i.e., the query/batch may be assigned to a partition that is able to satisfy the execution time minimum of the SLA according to the predicted execution time of the query/batch).

FIG. 1B illustrates the electronic device 100 and a server 200 according to one or more embodiments. For example, the electronic device 100 may include the host processor 110, the off-chip memory 120, and the memory controller 130. As illustrated in FIG. 1B, the server 200 may include the accelerator 140 (the electronic device 100 may or may not have its own accelerator). The accelerator 140 may include accelerators 140-1, 140-2, . . . , 140-n. For example, the server 200 may provide an AI model inference service using the accelerators 140-1, 140-2, . . . , 140-n. For convenience, a single accelerator 140 may be referred to herein for description, however, the single accelerator is applicable to implementations where there are multiple accelerators and any description of an accelerator 140 is applicable to one or more accelerator devices.

For example, the host processor 110 may form partitions by partitioning the accelerator 140 of the server 200. For example, the host processor 110 may determine a number of partitions (and possibly other partition parameters/settings). That is, the host processor 100 may determine the numbers of instances of partitions of different sizes. For example, the host processor 110 may determine the number of instances of partitions of different sizes and may accordingly partition each of the accelerators 140-1, 140-2, . . . , 140-n.

In one or more embodiments, the host processor 110 may schedule an input query/batch to the accelerator 140. For example, the host processor 110 may schedule an input query by determining which of the accelerator partitions of accelerators the 140-1, 140-2, . . . , 140-n the input query will be assigned to for execution. Scheduling is described further below.

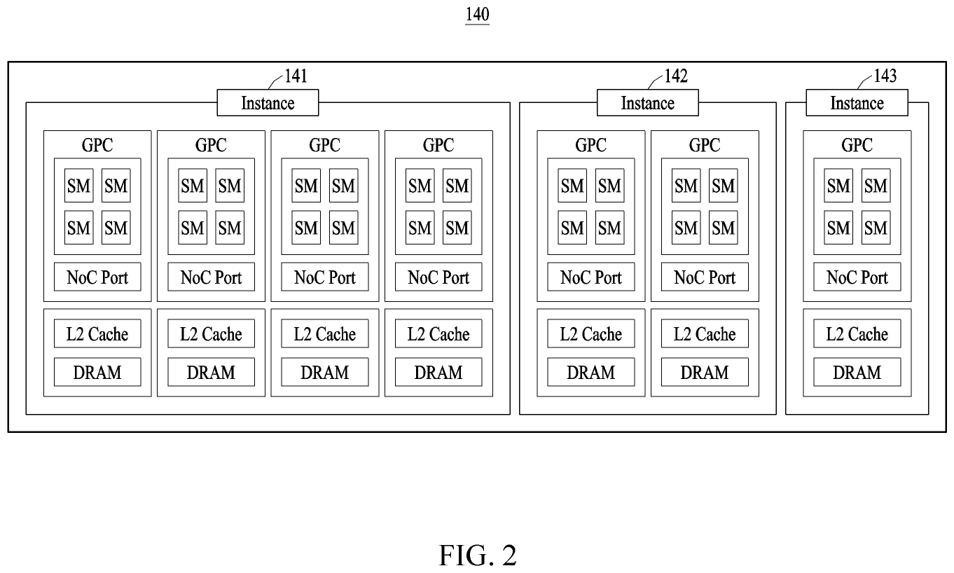

FIG. 2 illustrates the accelerator 140 as partitioned according to one or more embodiments. An architecture of the accelerator 140 illustrated in FIG. 2 is an example of a reconfigurable GPU. For example, the accelerator 140 may include a partitionable operation resource and the host processor 110 may set partitions (or instances) by partitioning the partitionable operation resource.

FIG. 2 illustrates a case in which the accelerator 140 is a GPU. However, techniques described herein are equally applicable when the accelerator 140 is an NPU, a TPU, a DSP, or a CPU, and in such implementations the host processor 110 of the electronic device 100 may partition the accelerator 140 in substantially the same manner as illustrated in FIG. 2, although the types of partitionable resources may differ.

Referring to FIG. 2, a graphics processing cluster (GPC) may be a processing unit that includes a configurable number of streaming multiprocessors (SM) and network-on-a-chip (NoC) ports. A memory slice may include cache memory (e.g., L2 cache) and DRAM.

For example, when the accelerator 140 is a GPU, a partition size may be deemed to be the number of GPCs in a partition. For example, the size of a first partition 141 including four GPCs may be 4, the size of a second partition 142 including two GPCs may be 2, and the size of a third partition 143 including one GPC may be 1.

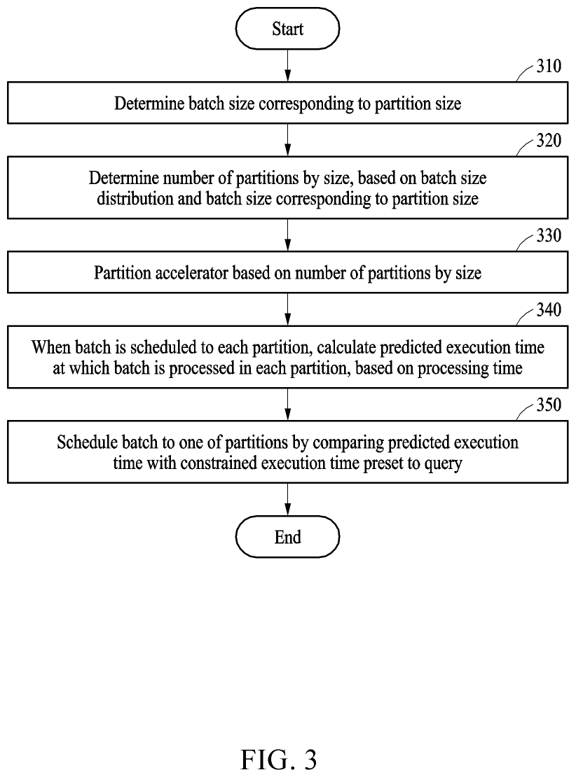

FIG. 3 illustrates an operation of partitioning an accelerator and an operation of scheduling a batch according to one or more embodiments. That is, FIG. 3 shows a process of first partitioning an accelerator and then scheduling batches according to the partitioning.

In operation 310, the host processor 110 may determine a batch size corresponding to a partition size. That is, the host processor 110 may determine or access information indicating correspondences between batch sizes and respective partition sizes. Such correspondences may be based on the partition size and resource utilization of a partition according to the batch size that is input to (or corresponds to) the partition.

The batch may represent a unit of data that is input to the accelerator 140 and processed at least one time by the accelerator 140. The batch may include pieces of data input to the accelerator 140 and processed. The batch size may correspond to (or be proportional to) the number of pieces of data processed at one time. For example, the batch size may represent the size of total data processed at one time.

For example, the resource utilization of a partition may be a time during which a resource of the partition (e.g., the GPC of FIG. 2) is utilized. For example, over time, high resource utilization of a partition occurs when the partition spends a high proportion of overall time utilizing a resource to process batches. For example, high resource utilization of a partition is when a given resource is efficiently utilized (has a low idle time).

As the batch size processed by a given partition increases, the resource utilization may increase however the latency to process the may increase in proportion to the size of the batch. The host processor 110 may determine the partition size for a corresponding batch size to satisfy a preset constraint (e.g., the SLA) for processing an input query while also increasing the resource utilization based on the partition size.

An increase in the batch size may be an increase in the number of pieces of data to be processed by a partition. Generally, when the number of pieces of data processed by the partition increases, the partition resource may be utilized for a longer period to process the batch in the partition, and thus, the resource utilization of the partition may increase. However, when the number of pieces of data processed by the partition increases, latency until the completion of the processing of the batch may increase since more time is required to process the batch in the partition.

For example, when an input batch is processed by each partition size and the resource utilization of the partition is equal to or greater than predetermined resource utilization (e.g., threshold resource utilization), latency may rapidly increase. The host processor 110 may determine which batch sizes should correspond with which partition sizes based on batch sizes at the threshold resource utilization in each partition size.

In operation 320, the host processor 110 of the electronic device 100 may determine the numbers of partitions of different sizes that are to be instantiated. For example, the host processor 110 may determine the numbers of partition instances of different sizes based on a historical batch size distribution and based on correspondences between the batch sizes and the partition sizes. For example, a batch size distribution may be a number of batches, by size, input to the electronic device 100 per unit time. In other words, a batch size distribution may be historical frequencies of respective batch sizes. For example, a batch size distribution may be statistically calculated by analyzing previously input queries. For example, the batch size distribution may be an average of the numbers of batches by sizes of the batches inputted per second to the electronic device 100.

For example, a batch size distribution may be a distribution based on the batch sizes included in queries processed by the accelerator 140. For example, when a given/predetermined batch size is input many times per unit of time, the host processor 110 may determine the number of partitions of a corresponding size to instantiate in proportion to the frequency of the given/predetermined batch size. Such may be performed for different batch sizes and different respectively corresponding partition sizes.

In operation 330, the host processor 110 of the electronic device 100 may partition the accelerator 140 to have various numbers of partitions for different partition sizes as determined by operation 320.

By operations 310, 320, and 330, the host processor 110 may partition the accelerator 140 such that the latency of processing new batches in the partitions satisfies a preset constraint condition and while increasing utilization of the accelerator 140.

To reiterate, for example, in operation 310, when a batch is to be processed by a partition, the host processor 110 may determine the partition size corresponding to the size of the batch such that the latency of the partition may not exceed the preset constraint condition while increasing the resource utilization. In operation 320, the host processor 110 may partition the accelerator 140 by determining the numbers of partitions of different sizes based on historical size distribution information of input batches such that the input batches may be efficiently processed. In operation 340, when a batch is scheduled to a partition (among available partitions),based on an estimated/predicted processing times for the batch by each of the partition sizes.

The processing times for a given batch may be determined based on the sizes of the partitions obtained by partitioning the accelerator and the size of the batch. As the partition size increases, the corresponding processing time for processing the batch in the partitions may decrease. As batch size increases, the processing time for processing the batch by a given partition size may increase.

For example, as shown in Table 1, the processing time may be determined based on the size of each partition and the size of the batch that is input to each partition. For example, when the partition size is 1 (e.g., 1 GPC of Table 1) and the batch size is 31, the processing time may be 56 ms. In Table 1, the top row lists examples of partition sizes.

TABLE 1

| Batch Size | 1 GPC | 2 GPCs | . . . | 7 GPCs |
|---|---|---|---|---|
| 1 | 20 ms | 20 ms | . . . | 20 ms |
| 2 | 22 ms | 20 ms | . . . | 20 ms |
| 3 | 25 ms | 21 ms | . . . | 20 ms |
| . . . | . . . | . . . | . . . | . . . |
| 31 | 56 ms | 30 ms | . . . | 25 ms |
| 32 | 65 ms | 32 ms | . . . | 25 ms |

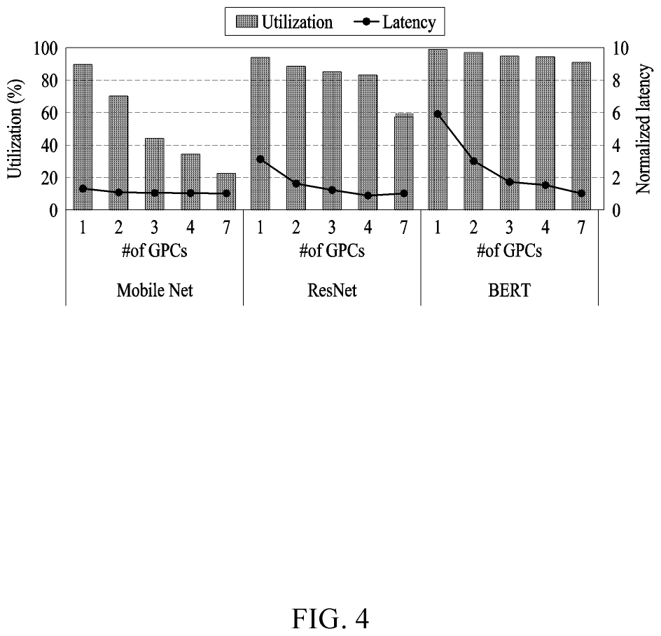

In one or more embodiments, the processing times may be determined by a NN model, which may be executed by the partitions or elsewhere. The processing time may be determined based on a NN model executed by the partitions in substantially the same manner as determining resource utilization and latency, which is described with reference to FIG. 4, based on a NN model executed by a partition. The means of determining processing times is not limited. For example, processing times can be estimated from formulas, historical data, and so forth. The component(s) which calculate predicted execution times based on the partition size may calculate predicted execution times by any of various methods, for example, based on heuristics, historical data, system metrics, associated resource usage, external indications (e.g., manually inputted estimates), compiler profiling data, etc.

For example, as described with reference to FIG. 9, when a batch is being scheduled (assigned to a partition), the host processor 110 may calculate predicted execution times (times to complete processing of the batch) for different respective partition sizes to process the batch being scheduled. For example, a predicted execution time for a given partition size may be calculated by a sum of (i) a remaining processing time of a batch that is currently being processed by the given partition, (ii) a processing time of a batch that is pre-scheduled to the partition, and (iii) a processing time of a batch to be scheduled.

In one or more embodiments, in operation 350, the host processor 110 may schedule a batch to one of the partitions by comparing the predicted execution times for the batch by the partition sizes to a constrained execution time (e.g., the SLA) that is associated with the query.

For example, a query may be a request to be processed by the accelerator 140, where the request is received from an external electronic device configured to be connected to the electronic device 100 and communicate with the electronic device 100. For example, the accelerator 140 may be operated by a server to provide a network or cloud service for processing network-based requests for clients. The query may include a batch to be computed in the accelerator 140 and scheduling the network/cloud query to a partition may be substantially the same as scheduling any other batch to a partition. For example, a constrained execution time may be set to the query.

For example, the host processor 110 may schedule a batch to one of the partitions for which the predicted execution time of the batch is less than the constrained/required execution time associated with the batch (e.g., by an SLA or the like).

For example, the host processor 110 may schedule a batch to the smallest partition, among the partitions, for which the predicted execution time is less than the constrained execution time. The host processor 110 may increase resource utilization by scheduling batches to the smallest partitions whose predicted execution times can satisfy the constrained execution times.

In operations 340 and 350, the host processor 110 may schedule a query to a partition such that the query is processed by the constrained execution time that is preset to the query.

FIG. 4 illustrates resource utilization and latency based on a NN model, according to one or more embodiments. Resource utilization may be determined by a NN model. For example, an operation based on the NN model may be performed by a partition and resource utilization may vary depending on a characteristic of the NN model.

For example, as illustrated in the example 400 of FIG. 4, when an operation based on each NN model (e.g., Mobile Net, residual neural network (ResNet), bidirectional encoder representations from transformers (BERT)) is performed by a partition, resource utilization and latency may vary depending on the size of the partition (e.g., # of GPCs).

The host processor 110 may determine a batch size that is correspond to a partition size based on resource utilization determined based on the NN model that is executed by the partition. The host processor 110 may partition the accelerator 140 based on the NN model executed by the partition.

Referring to FIG. 4, the host processor 110 according to one or more embodiments may partition the accelerator 140 by considering an operation characteristic, the size (e.g., the number or size of input layers, hidden layers, and output layers), and a connection relationship of the NN model executed by the partition. For example, resource utilization based on the partition size and the batch size may be determined based on the operation characteristic, size, and connection relationship of the NN model executed by the partition. The host processor 110 may partition the accelerator 140 based on the operation characteristic, size, and connection relationship of the NN model by partitioning the accelerator 140 considering the resource utilization.

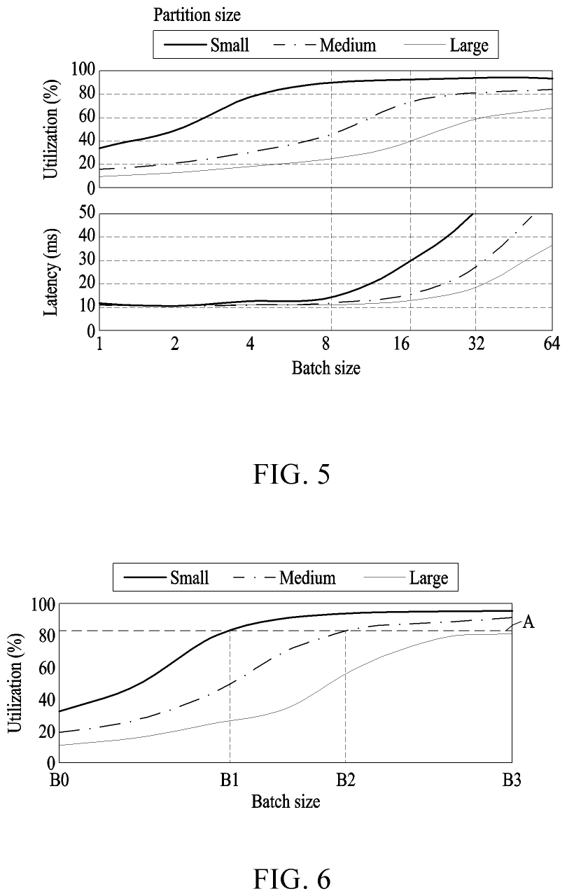

FIG. 5 illustrates resource utilization and latency based on a partition size and a batch size, according to one or more embodiments. In the example 500 of FIG. 5, the partition sizes small, medium, and large may be the partitions with 1 GPC, 3 GPCs, and 7 GPCs, respectively, in the GPU of FIG. 2.

As illustrated in FIG. 5, resource utilization of the partition may be determined by the partition size (e.g., small, medium, and large) and the batch size. For example, as the size of input batches increase, resource utilization of a given partition size may increase. For example, when a batch with the same size is input to any of the partition sizes, resource utilization may decrease as the sizes of the partitions increases.

As illustrated in FIG. 5, as the batch size processed by each partition size increases, latency may increase. When a batch of the same size is processed, latency may decrease as the partition size increases.

Referring to FIG. 5, as the batch size processed by each partition size increases, resource utilization and latency may increase. For example, when resource utilization of the partition is equal to or greater than a predetermined value, latency may rapidly increase. The predetermined value of resource utilization in which the latency rapidly increases may be used as a resource utilization threshold.

FIG. 6 illustrates a batch size corresponding to a partition size determined based on threshold resource utilization A. The host processor 110 may determine a batch size corresponding to a partition size, based on the batch size when resource utilization of the partition corresponds to preset threshold resource utilization A.

As shown in the example 600 of FIG. 6, the batch size B1 may be the batch size at which resource utilization of the small size partition corresponds to the threshold resource utilization A. The batch size B2 may be the batch size at which resource utilization of the medium size partition corresponds to the threshold resource utilization A. The batch size B3 may be the batch size at which resource utilization of the large size partition corresponds to the threshold resource utilization A.

Referring to FIG. 6, the host processor 110 may determine the batch size corresponding to the small partition to be less than B1 and greater than or equal to B0. The host processor 110 may determine the batch size corresponding to the medium partition to be less than B2 and greater than or equal to B1. The host processor 110 may determine the batch size corresponding to the large partition to be less than B3 and greater than or equal to B2.

The “batch size corresponding to the partition size” may refer to the batch size for which resource utilization is less than the threshold resource utilization when a batch of the batch size (which corresponds to the size of a partition) is processed by the partition. For example, when a batch of size less than B1 and greater than or equal to B0 is processed by a small size partition, resource utilization may be less than the threshold resource utilization, in other words, the resource utilization may be less than the threshold resource utilization and the latency may be small when the batch is processed by the partition.

In one or more embodiments, the batch sizes corresponding to the partition sizes may be determined based on the performance of the accelerator 140. For example, as illustrated in

FIGS. 5 and 6, resource utilization and latency based on the partition size and the batch size may be determined based on historical or modeled performance of the accelerator 140.

FIGS. 5 and 6 illustrate an example where the host processor 110 determines batch sizes corresponding to partition sizes, based on a preset resource utilization threshold (e.g., A). However, unlike FIGS. 5 and 6, the host processor 110 may instead determine the batch sizes corresponding to the partition sizes based on a preset threshold latency. For example, the threshold latency may be a time by which batches are to be processed by partitions. For example, the threshold latency may be a time from the beginning of processing a batch in a partition to the end of the processing.

For example, referring to FIG. 5, the host processor 110 may determine batch sizes corresponding to partition sizes based on batch sizes at which a latencies based on each partition size and batch size corresponds to the threshold latency (e.g., 20 ms). For example, when the latency of a batch having a size of 12 for a small partition is 20 ms, the host processor 110 may determine the batch size corresponding the small size partition to be less than 12 and greater than or equal to 1. For example, when the latency of a batch having a size of 26 in a medium size partition is 20 ms, the host processor 110 may determine the batch size corresponding to the medium size partition to be less than 26 and greater than or equal to 12.

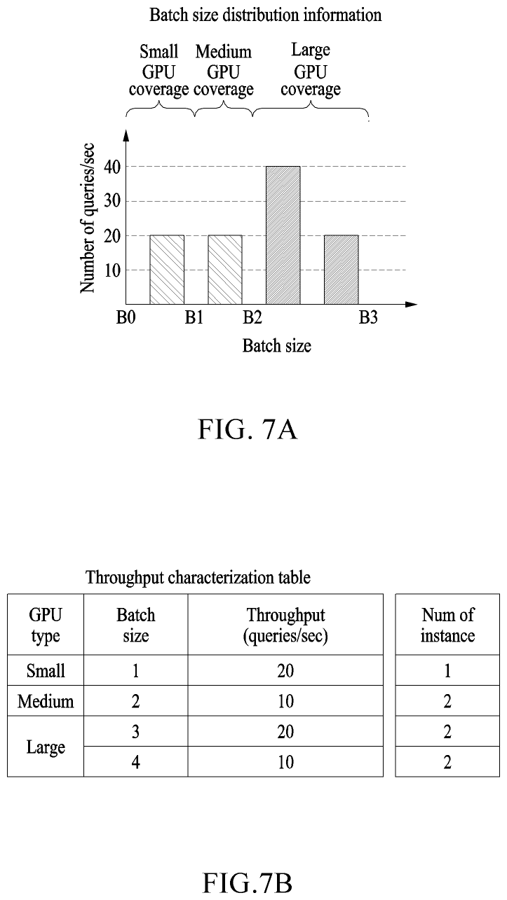

FIGS. 7A and 7B illustrate numbers of instances of partitions of different sizes as determined based on a batch size distribution according to one or more embodiments. FIGS. 7A and 7B illustrate an example where the host processor 110 determines the numbers of instances of partitions of different partition sizes (e.g., numbers of small, medium, and large partitions). In the example of FIGS. 7A and 7B, a batch size of 1 corresponds to the small partitions, a batch size of 2 corresponds to the medium partitions is 2, and batch sizes of 3 and 4 correspond to the large partitions.

FIG. 7A illustrates an example 700A of a batch size frequency distribution according to one or more embodiments. That is, FIG. 7A shows how frequently batches of different sizes are queried. For example, the batch size distribution shown in FIG. 7A may be obtained by accumulating statistics about query inputs to the electronic device 100, for example counting the batch sizes of the queries over time and finding the average query rates (e.g., per second) of batches of different sizes. For example, the batch size distribution of FIG. 7A represents an average frequencies (e.g., per second) of batches by size as obtained by analyzing query inputs to (or generated by) the electronic device 100. For example, referring to FIGS. 7A and 7B, queries with a batch size of 1 have been determined to have 20 queries per second input to the accelerator 140.

In the batch size frequency distribution illustrated in FIG. 7A, the batch size 1 (corresponding the small partition) had 20 queries input per second, the batch having a size of 2 (corresponding to the medium size partition) had 20 queries input per second, and the batches having sizes of 3 and 4 (corresponding to the large size partition) had, respectively, 40 and 20 queries input per second.

FIG. 7B illustrates a throughput characterization table based on partition sizes according to one or more embodiments. The example 700B shown in FIG. 7B is a transposition of the batch size frequency distribution in FIG. 7A, with the addition of numbers instances of partitions of different sizes. The host processor 110 of the electronic device 100 may determine (or predict) the number of instances of partitions of different sizes to be used based on the batch size frequency distribution, and more specifically, based on the batch size frequencies corresponding to their respective partition sizes. For example, the host processor 110 may assign more instances of partitions for partition sizes having higher batch/request frequencies.

For example, the host processor 110 may determine the numbers of partition instances for different respective partition sizes by considering throughputs (frequencies) based of the batch sizes corresponding to the partition sizes.

The throughput characterization table of FIG. 7B includes throughput of a small partition being 10 queries per second (for queries with a batch size of 1), throughput of a medium partition being 20 queries per second (for queries with a batch size of 1), throughput of a large partition is (i) 20 queries per second (for queries with a batch with a size of 3) and (ii) 10 queries per second (for queries with a batch with a size of 4).

By considering throughputs based on the partition sizes and the batch sizes, the host processor 110 may determine the number of small partition instances to be 1, the number of medium partition instances instances to be 2, and the number of large partition instances instances to be 4.

For example, the throughputs represent processing frequencies at which the partitions of different sizes process queries. For example, referring to FIG. 7B, one small partition may process 20 queries per second for the batch size is 1. Referring to FIG. 7A, in the batch size distribution, since 20 queries per second having a batch size of 1 are input, the host processor 110 may determine the number of small partition instances to be 1. While various other factors may contribute to determining how many instances are needed, and while such determinations will necessarily vary from one context or system to the next, determining how many instances for different partitions sizes may nonetheless be based in part on their request/batch frequencies.

Similarly to the small partition, the host processor 110 may determine the number of medium partition instances to be 2 in order to process 20 queries (having a batch size of 2) per second. The host processor 110 may determine the number of large partition instances to be 4 in order to process 40 queries (having a batch size of 3) and 20 queries (having a batch size of 4) per second.

In the example described above, the host processor 110 may determine the numbers of partition instances for different sizes such that the batch size frequency distribution corresponds to the number of instances of partitions by size.

For example, the host processor 110 may partition the accelerator 140 based on the numbers of partition instances for different respective partition sizes based on the throughput/frequency information (e.g., distribution). For example, the partition sizes small, medium, and large may respectively be partitions formed to have 1 GPC, 3 GPCs, and 7 GPCs in the GPU of FIG. 2. When the accelerator 140 includes 35 GPCs in total, the host processor 110 may partition the accelerator 140 into four large partitions, two medium partitions, and one small partition.

For example, referring to FIG. 7B, the number of partition instances may represent a ratio of partitions by size. For example, when the accelerator 140 includes N GPCs, the host processor 110 may partition the accelerator 140 such that a sum of the number of partitions that are small, medium, and large sizes is N and the ratio thereof is 1:2:4. Such ratios may be used to determine the sizes (amounts of resources such as GPCs) of the partitions. For example, the batch size distribution of FIG. 7A may change depending on a size distribution of batches included in an input query. For example, the electronic device 100 may re-partition the accelerator based on the changed batch size distribution.

As can be seen, when the accelerator 140 is partitioned in a way that aligns sizes and numbers of instances of partitions with the historical frequencies of different queries/batches, the partitioning of the accelerator may significantly improve the utilization of the resources of the accelerator 140 (if future queries/batches somewhat follow their historical pattern) while potentially satisfying latency requirements or the like.

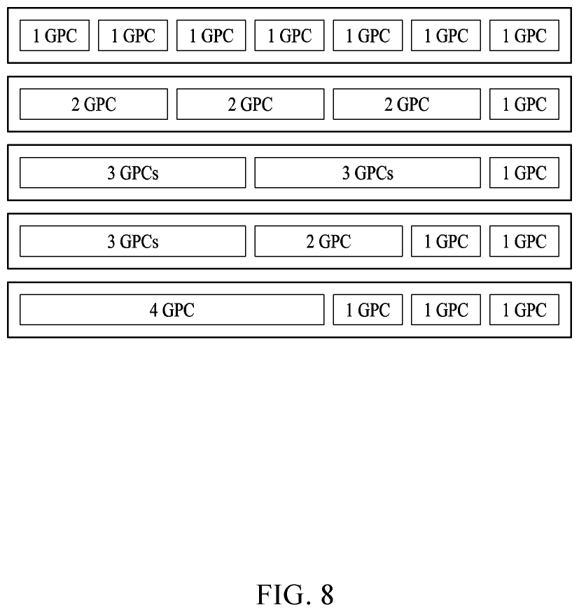

FIG. 8 illustrates accelerator partitioning according to one or more embodiments. In the example of FIG. 8, when the accelerator 140 is a GPU including 7 GPCs. The host processor 110 may partition the accelerator 140 into various sizes and numbers, as illustrated in FIG. 8. In one embodiment, FIG. 8 represents an example where the electronic device 100 includes multiple accelerators 140 and the host processor 110 partitions the accelerators 140 as shown by each of the horizontal boxes in FIG. 8 (different accelerators may in practice have different amounts of resources/GPCs).

FIG. 9 illustrates a calculated predicted execution time for a new query according to one or more embodiments. The host processor 110 may calculate a predicted execution time (duration) to process a batch when the batch is scheduled to a partition, based on a processing time. In FIG. 9, processing execution time may be obtained by adding a waiting time T_{wait} to a processing time T_{new}.

For example, the waiting time T_{wait} may be calculated as a sum of the remaining processing time T_{remaining,current} for a currently processed batch and a processing time Σ(T_{estimated,queued}) of a batch pre-scheduled to the partition, as Equation 1.

T_{wait}=Σ(T_{estimated, queued})+T_{remaining,current} Equation 1

For example, the host processor 110 may calculate the waiting time T_{wait} and the processing time T_{new} of an input batch by using the processing time of Table 1 above.

In one embodiment, the host processor 110 may calculate an SLA slack as Equation 2 shown below. In Equation 2, T_{estimated,new} may denote a processing time of an input batch, T_{new} and SLA_{target} are respectively constrained execution times preset to a query, and α and β are respective parameters configured to set prediction performance of the SLA slack, based on a unique environment of the electronic device 100 including the accelerator 140 and/or the server 200, respectively.

SLAslacl=SLA_{target}−α(T_{wait}+β·T_{estimated,new}) Equation 2

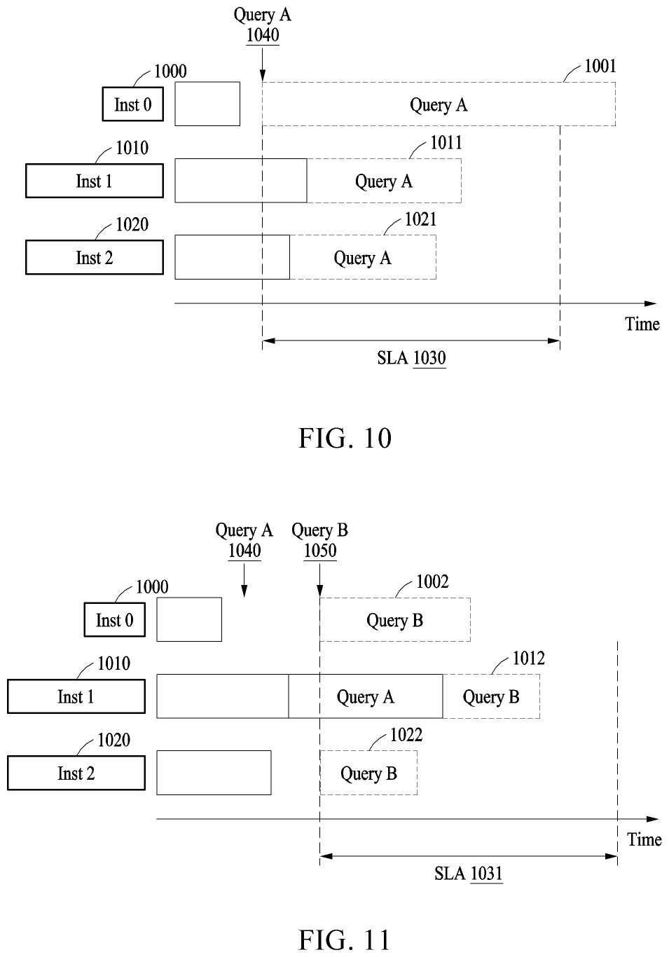

FIGS. 10 and 11 illustrate an operation of scheduling a query including a batch to partitions, according to one or more embodiments.

FIG. 10 illustrates, when a query A 1040 is input to the accelerator 140, a query A predicted execution time 1001 of a partition 1000 (e.g., Inst0 of FIG. 10), a query A predicted execution time 1011 of a partition 1010 (e.g., Inst1 of FIG. 10), and a query A predicted execution time 1021 of a partition 1020 (e.g., Inst2 of FIG. 10). In FIG. 10, the size of the partition 1000 may be less than the size of partitions 1010 and 1020 and the size of the partition 1010 may be the same as the size of the partition 1020.

Referring to FIG. 10, the host processor 110 may schedule a batch to one of the partitions by comparing the predicted execution time with the constrained execution time preset to the batch. For example, the host processor 110 may schedule a batch to a partition in which the predicted execution time is ahead of the constrained execution time.

For example, referring to FIG. 10, the end of constrained execution time (e.g., an SLA 1030) that is set to the query A may be ahead of (earlier than) the end of the query A predicted execution time 1001 of the partition 1000 and the end of the query A predicted execution time 1011 of the partition 1010 and the end of the query A predicted execution time 1021 of the partition 1020 may be ahead of the constrained execution time 1030 set to the query A. The host processor 110 may schedule the query A to one of the partitions 1010 and 1020 in which the respective predicted execution times 1011 and 1021 are ahead of the constrained execution time 1030. Scheduling the query A may involve assigning a batch included in the query A to one of the partitions 1000, 1010, and 1020.

FIG. 11 illustrates a case in which the host processor 110 has scheduled the query A 1040 to the partition 1020 in FIG. 10 and a query B 1050 is input.

For example, the host processor 110 may schedule a batch to a partition having the smallest size among partitions in which predicted execution times 1002, 1012, 1022 are ahead of (satisfy) the constrained execution time 1031 of the batch. Execution time constraints or the like may vary for different requests, which in some implementations may be associated with different users and different SLAs.

Referring to FIG. 11, when a query B 1050 is evaluated to be scheduled to partitions 1000, 1010, and 1020, the end of the query B predicted execution times 1002, 1012, and 1022 may be ahead of the end of a constrained execution time (e.g., an SLA 1031) of the query B. Referring to FIG. 11, the host processor 110 may schedule the query B 1050 to the partition 1000 having the smallest size among the partitions that meet the SLA 1031.

The host processor 110 may thus increase resource utilization of the accelerator 140 by scheduling a batch to the smallest partition among partitions for which respective predicted execution times are ahead of the constrained execution time.

In some embodiments, when there are no partitions for which the respective predicted execution times are ahead of the constrained execution time, the host processor 110 may schedule the batch to a partition having the earliest predicted execution time. For example, in the example illustrated in FIG. 11, when the query B 1050 is scheduled to the partitions 1000, 1010, and 1020 and the constrained execution time of the query B is ahead of the query B processing execution times 1002, 1012, and 1022, the host processor 110 may schedule the query B 1050 to the partition 1020 having the earliest predicted execution time.

Although embodiments are described above with reference to batches of neural network data, the techniques for partitioning accelerators and assigning batches to partitions are not limited to any particular type of data. Rather, the techniques may be used regardless of the type of data in the batches.

The computing apparatuses, the electronic devices, the processors, the memories, the displays, the information output system and hardware, the storage devices, and other apparatuses, devices, units, modules, and components described herein with respect to FIGS. 1-11 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD- Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device comprising:
one or more processors; and
a memory storing instructions configured to cause the one or more processors to:
based on resource utilization of partitions of different sizes, for batches of different sizes input to the partitions of different sizes, determine correspondences between the sizes of the batches and the sizes of the partitions;
determine numbers of partitions for the respective determined sizes of the partitions based on numbers of the batches and the correspondences between the sizes of the batches and the sizes of the partitions; and
partition the accelerator into partitions based on the determined numbers of the respective sizes of the partitions.

2. The electronic device of claim 1, wherein the resource utilization is determined based on a neural network (NN) model executed by the partitions.

3. The electronic device of claim 1, wherein the instructions are further configured to cause the one or more processors to determine the correspondences between the sizes of the batches and the sizes of the partitions based on a size of a batch corresponding to when the resource utilization of a partition corresponds to a preset threshold resource utilization.

4. The electronic device of claim 1, wherein the instructions are further configured to cause the one or more processors to determine the numbers of partitions of respective sizes according to throughput based on the sizes of the partitions and the sizes of the batches.

5. The electronic device of claim 4, wherein the instructions are further configured to cause the one or more processors to determine the numbers of partitions of respective sizes such that the number of batches by size corresponds to the number of batches by size which are processible based on the numbers of partitions of respective sizes.

6. The electronic device of claim 1, wherein the instructions are further configured to cause the one or more processors to:
when a batch is scheduled to the accelerator, calculate predicted execution times processing the batch by each of the respective partition sizes, based on a processing time determined based on the size of one or more partitions obtained by partitioning the accelerator and the size of the batch input to the partitions, and
assign the batch to one of the partitions by comparing the predicted execution times with an execution time requirement that is associated with the batch.

7. The electronic device of claim 6, wherein the processing times are determined based on a neural network (NN) model executed by the partitions.

8. The electronic device of claim 6, wherein the instructions are further configured to cause the one or more processors to schedule the batch to a smallest partition among partitions for which the respectively corresponding predicted execution times meet the execution time requirement.

9. An electronic device comprising:
one or more processors; and
a memory storing instructions executable by the processor,
wherein, in response to the instructions being executed by the one or more processors, the one or more processors:
based on a processing time determined based on a size of one or more partitions obtained by partitioning an accelerator and a size of a batch input to each of the partitions, when the batch is scheduled to the accelerator, calculate predicted execution times for completing processing of the batch for each of the respective sizes of the partitions, and
schedule the batch to one of the partitions by comparing the predicted execution times with an execution time requirement associated with the batch.

10. The electronic device of claim 9, wherein the processing times are determined based on a neural network (NN) model executed by the partitions.

11. The electronic device of claim 9, wherein the instructions further configure the one or more processors to calculate the predicted durations based on a remaining processing time of a batch that is currently processed by one of the partitions, a processing time of a batch that is already scheduled to one of the partitions, and a processing time of the batch.

12. The electronic device of claim 9, wherein the instructions further configure the processor to schedule the batch to a smallest partition size among partition sizes for which the corresponding predicted execution times are earlier than the execution time requirement.

13. A method of managing an accelerator device that can be reconfigured to have different partitions that are capable of executing batches, the method comprising:
providing associations between batch sizes and respective partition sizes, the batch sizes comprising amounts of data in the corresponding batches, the partition sizes comprising amounts of processing resources of the corresponding partitions;
instantiating a number of instances of partitions for each of the respective partition sizes based on information about frequencies of batches for the respective batch sizes; and
assigning batches to the instantiated instances of partitions, wherein the batches are assigned to instances of partitions that have partition sizes associated with, according to the associations, the sizes of the batches.

14. The method of claim 13, wherein the associations are determined based on a resource utilization threshold.

15. The method of claim 13, wherein the information about frequencies of batches for the respective batch sizes is determined based on statistics of the sizes of partitions and the sizes of batches.

16. The method of claim 13, wherein numbers of instances of partitions for the respective partition sizes are determined such that the number of instances of a partition of a given size is proportional to a frequency of processing batches of a corresponding size.

17. The method of claim 13, wherein the accelerator device comprises a multi-instance graphics processing unit (GPU).

18. The method of claim 17, wherein a partition size correspond to a number of graphics processing clusters.

19. The method of claim 13, wherein the assigning of a batch to an instantiated instance of a partition further comprises predicting execution times of the batch for the respective partition sizes and assigning the batch to an instance of a partition having the lowest predicted execution time.

20. The method of claim 13 the associations between the batch sizes and the respective partition sizes are determined based on historical statistics of executions of previous batches by previous partitions of the accelerator having the partition sizes.
